(19) United States
(12) Patent Application Publication
(10) Pub. No.: US 2018/0029770 A1
(43) Pub. Date: Feb. 1, 2018

(54) SUPPLY CARTRIDGE WITH BINARY CODE, MACHINE FOR PREPARING BEVERAGES AND PROCESS FOR OPERATION OF A MACHINE USING SAID SUPPLY CARTRIDGE

(71) Applicant: NOVADELTA - COMERCIO E INDUSTRIA DE CAFES S.A., Lisboa (PT)

(72) Inventor: Rui Miguel NABEIRO, Campo Maior (PT)

(73) Assignee: NOVADELTA - COMERCIO E INDUSTRIA DE CAFES S.A., Lisboa (PT)

(21) Appl. No.: 15/550,128

(22) PCT Filed: Feb. 11, 2016
(86) PCT No.: PCT/PT2016/050005

§ 371 Date: Aug. 10, 2017

(30) Foreign Application Priority Data
Feb. 11, 2015 (PT) 108210

(51) Int. Cl. B65D 75/32; A47J 31/44

(52) U.S. Cl. CPC B65D 75/323; A47J 31/4492; B65D 2203/00

(57) ABSTRACT

The present invention refers to a supply cartridge (1) comprising a support (2) of single portions, provided as a flexible strip-like support, or similar, and presenting a plurality of single dose portions (21) of an edible substance, such as for example coffee, disposed successively along a respective longitudinal direction. In particular, said support (2) of single portions presents a plurality of holes (25) adapted so as to provide a binary code for recognition by a machine (10) for preparing beverages of a set of parameters associated with said supply cartridge (1).

The present invention further refers to a machine (10) for preparing beverages, adapted for using a supply cartridge (1), including code apprehension means (7) provided in functional connection with a control device (8) of said machine (10), as well as to a process of preparation of beverages based upon a machine (10) for preparing beverages according to the present invention.

### FIELD OF THE INVENTION

The present invention refers to the field of supply cartridges adapted for collection of a support of single portions, provided as a flexible strip-like support, or similar, and presenting a plurality of single dose portions of an edible substance disposed successively along a respective longitudinal direction.

The present invention further refers to a machine for preparing beverages adapted for using a supply cartridge of the type of the present invention, as well as to a process for preparing beverages by means of a machine and supply cartridge of the type of the present invention.

### BACKGROUND OF THE INVENTION

The prior art includes several solutions relating to beverage preparation machines based on edible substances, and adapted so as to process a plurality of single doses provided in a strip-like or similar support that is displaced out of a supply cartridge so as to successively supply an extraction device adapted so as to extract a respective beverage.

Document GB 2288972 B also discloses a supply cartridge according to the present invention. This document discloses a support of single portions that presents holes in the peripheral side zones of all dividing regions between successive single doses, whereby said holes are adapted so as to engage in corresponding engagement elements of an actuation device provided in a corresponding machine for preparing beverages.

Document U.S. Pat. No. 5,555,790 also discloses a support configured in a strip from and presenting a plurality of single doses, whereby said strip presents in each dividing region between single dose portions, a first set of holes with a given form and dimension and a second set formed by a single hole of different form and dimension of the holes of said first set, whereby said holes are adapted to provide a better positioning and fixation of the strip relative to a mechanic interface.

Document WO 2013/169134 A2 filed by the applicant of the present invention, discloses a machine for preparing beverages of the same type and adapted for processing a support of conduction that provides a substantially hermetic envelope to a plurality of single doses.

None of the documents in the prior art discloses a cartridge adapted for collecting a support of single portions that provides information means adapted so that can be recognized and/or apprehended by corresponding means provided in the machine.

### GENERAL DESCRIPTION OF THE INVENTION

The objective of the present invention is to provide a supply cartridge comprising a package, provided for example in a generally parallelepiped form so that can collect a strip-like support, or similar, common to multiple single portions, and adapted for use in a machine for preparing beverages, such as for example espresso type coffee, tea and similar, notably by means of extraction of aromatic substances packaged in said single dose portions, whereby said support of single portions provides simple and reliable information means, in particular in the form of code, adapted so that provides at least one information parameter associated to the type of aromatic substance and the relative position of certain single dose portions along the extension of said support of single portions.

This objective is solved according to the present invention by means of a supply cartridge according to claim 1.

In particular, said objective is solved according to the present invention by means of a support of single portions that presents a plurality of holes disposed along a single cross alignment in the dividing region between successive single dose portions, whereby said holes vary in at least one respective dimensional parameter, at least between two dividing regions, preferentially non consecutive, of single dose portions along the extension of said support.

According to a preferred embodiment, the supply cartridge further presents an information device, preferentially of RFID type, whereby said information device is provided in a front face and in the same relative position of the cartridge in relation to the front zone of a collection disposition provided in a machine for preparing beverages.

Another objective of the present invention is to provide a machine for preparing beverages adapted for using a supply cartridge comprising a support of single portions, and that provides means for apprehending an information code provided in said support of single portions so as to improve the operation of said machine.

This objective is solved according to the present invention by means of a machine for preparing beverages according to claim 10.

Another objective of the present invention is to provide a process for preparing beverages by means of a machine for preparing beverages adapted for using a cartridge comprising a support of single portions, and that includes the apprehension of information provided in said support of single portions and respective use by a control device of a machine for preparing beverages.

This objective is solved according to the present invention by means of a process according to claim 13.

### DESCRIPTION OF THE FIGURES

The invention shall now be explained in greater detail based upon preferred embodiments thereof and the Figures attached.

The Figures show, in simplified schematic representations:

FIG. 1: top view of a support (2) of single portions (on the left-side) and side view of a single dose portion (21) (on the right-side) according to prior art;

FIG. 2: side view (on the top, left-side) and front view (on the top, right-side), as well as detail P01 (on the bottom), of a machine (10) for preparing beverages according to prior art, adapted for using a supply cartridge (1) that includes a support (2) of single portions according to FIG. 1;

FIG. 3: top views of two preferred embodiments of a support (2) of single portions of a supply cartridge (1) according to the present invention;

FIG. 4: top views of two preferred embodiments of a support (2) of single portions of a supply cartridge (1) according to the present invention;

FIG. 5: top views of two preferred embodiments of a support (2) of single portions of a supply cartridge (1) according to the present invention;

FIG. 6: side view (left-side) and front view of a machine for preparing beverages (10) with a first embodiment of a supply cartridge (1) according to the present invention;

FIG. 7: side view (left-side) and front view of a machine (10) for preparing beverages with a second embodiment of a supply cartridge (1) according to the present invention;

FIG. 8: side view of a code reading device provided in a machine (10) for preparing beverages according to the present invention.

### DESCRIPTION OF PREFERRED EMBODIMENTS OF THE INVENTION

As referred above, there are known several solutions in the prior art of supply cartridges (1) adapted for use in a machine (10) for preparing beverages and collecting a strip-like, or similar, support (2) of single portions inside thereof, and presenting a plurality of single dose portions (22) provided successively along a respective extension (E).

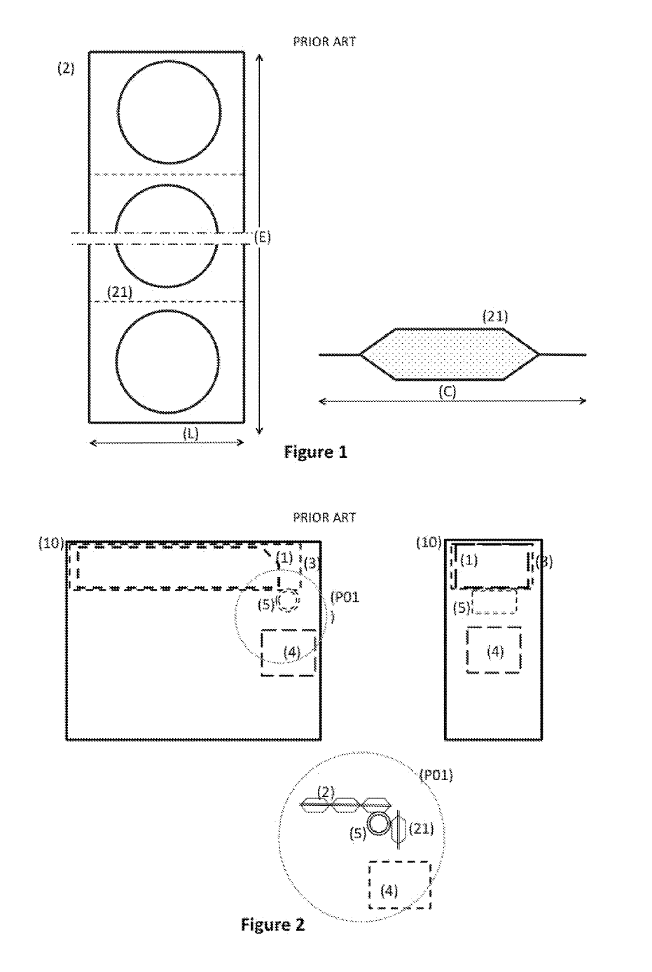

FIG. 1 represents views of a support (2) of single portions according to the prior art, whereby said single dose portions (21) present a length (C) along the direction of said extension (E), and a width (L) along a cross direction.

FIG. 2 represents a machine (10) for preparing beverages according to the prior art, adapted so as to use a supply cartridge (1) that comprises a support (2) of single portions of the type represented in FIG. 1. As one can observe, said machine (10) presents at least one collection disposition (3) adapted to fixate said supply cartridge (1), at least one extraction device (4) adapted so that can collect said single dose portion (21) inside thereof, and at least one actuation device (5) disposed downstream of said supply cartridge (1) and upstream of said extraction device (4) and provided so that can move said support (2) of single doses by means of rotation and thereby supply respective single dose portions (21) successively to said extraction device (4).

In particular, as one can better observe in detail P01 of FIG. 2, said actuation device (5) is adapted so that can rotate and that way exert a traction force upon a downstream edge of said support (2) of single portions, thereby moving the furthest downstream single dose portion (21) from a substantially horizontal displacement direction to a substantially vertical displacement direction, to a position where it is separated from the remanding support (2) of single portions and falls under the action of the gravity force inside of said extraction device (4).

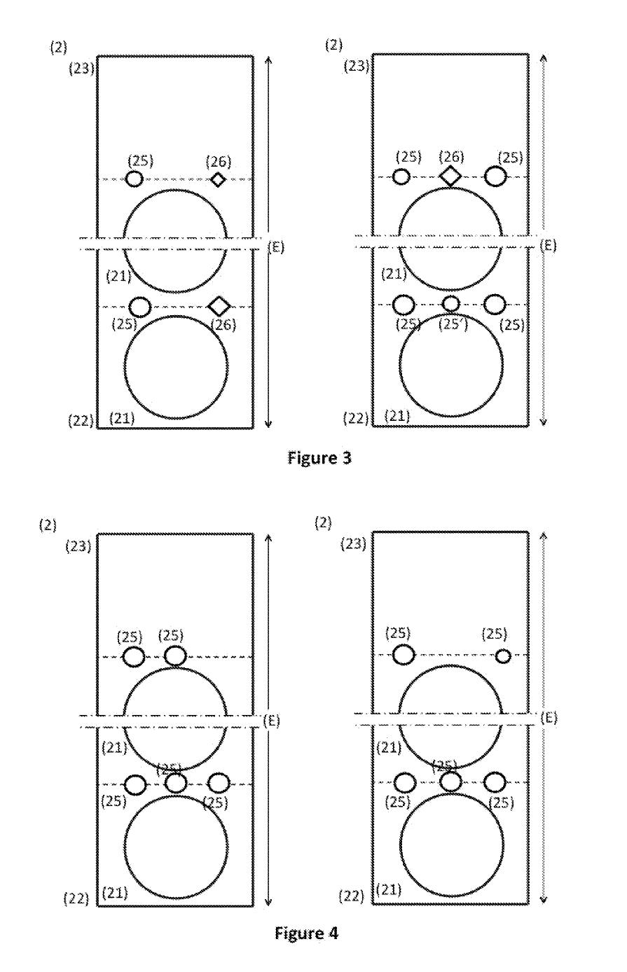

FIG. 3 represents a first set of embodiments of a support (2) of single portions contained in a supply cartridge (1) according to the present invention.

As one can observe, in both cases said support (2) of single portions presents holes (25, 26) in the dividing region between successive single dose portions (21). In particular, according to a first inventive aspect, there are provided at least two holes of different form (25, 26) and/or dimensions (25, 25′) (drawing on the left-side), so that can be individually recognized as a result of the variation of a beam of light projected upon them by information apprehension means (7) provided in the machine (10), as shall be described in greater detail further below.

In this respect, at least one of said holes (26) can present a geometric form that varies for example in the case of a given type of beverage, such as coffee, tea, or other edible substance. Moreover, as depicted in the embodiment represented on the left side, said holes (25, 26) present a decreasing dimension along the support extension (E), so that this provides an indication on the part thereof that has already been used and, therefore, the number of single dose portions (21) still remaining.

According to a preferred embodiment, said holes (25, 26) are provided in a single cross alignment in dividing regions between successive single dose portions (21), preferentially at least in the dividing region between a first and a second single dose portion (21). According to another preferred embodiment, said holes (25, 26) are provided in only part of the dividing regions between successive single dose portions (21) along the support extension (E) of said support (2) of single portions.

Alternatively, according to said inventive aspect, the support (2) of single portions presents at least three holes (25, 25′, 26) of different or similar form and/or dimension (drawing on the right side). In this case, in a first region there are provide two holes (25) of similar form and characteristic dimension and one hole (25′) of different dimension, in this case diameter. This variation can serve to identify the total number of single dose portions (21) available in that support (2) of single portions and, therefore, in the respective supply cartridge (1).

According to a preferred embodiment, at least one of said holes (26) can therefore present a different form in at least one upstream disposition of holes (25, 26), so as to convey other type of relevant information to a respective beverage preparation process.

FIG. 4 represents a second set of embodiments of a support (2) of single portions contained in a cartridge (1) according to the present invention.

In a first embodiment (drawing on the left), the support (2) of single portions presents a sequence of three holes (25) at given reference positions along a respective extension (E), whereby said sequence can vary for example so that one of said holes (25) is absent in at least one dividing region between successive single dose portions (21).

In the case of a second embodiment (drawing on the right side), there is provided a variation of the number and of the dimension of some of said holes (25). As it shall be readily understood, it is herewith provided a binary code whereby a given information parameter is associated with a given set or sequence of holes (25).

In dimensional terms, according to a preferred embodiment, said support (2) of single portions presents a plurality of single does portions (21) with a length (C) between 40 and 70 mm, preferentially between 50 and 60 mm. Moreover, said support (2) of single portions presents between 10 to 120 single dose portions (21), preferentially between 20 to 80 single dose portions along a respective extension (E).

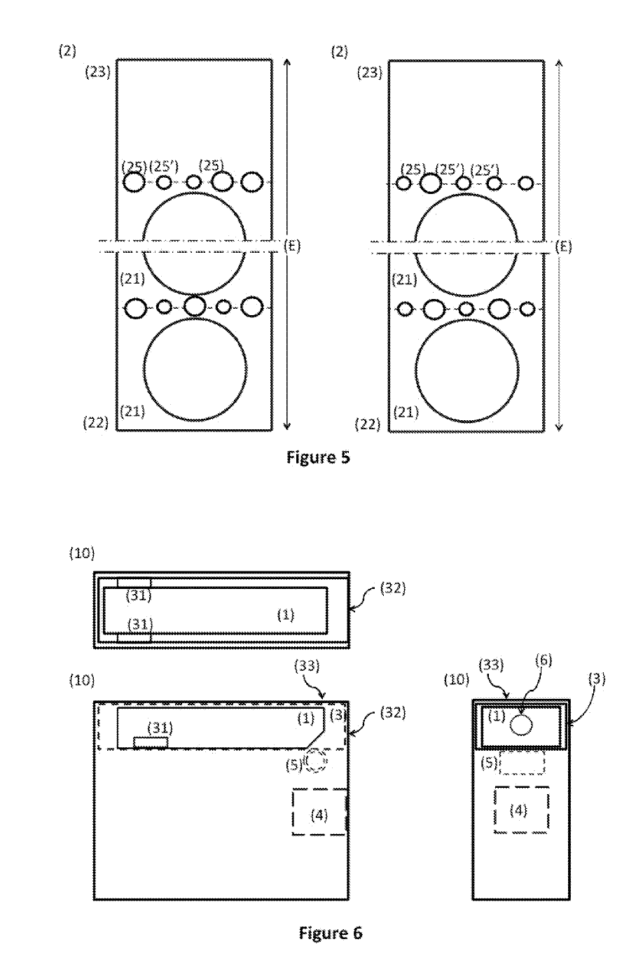

FIG. 5 represents a third set of embodiments of a support (2) of single portions contained in a supply cartridge (1) according to the present invention.

In this case, both supports (2) of single portions comprise five reference positions presenting holes (25, 25′) in dividing regions between successive single dose portions (21), whereby there is provided a variation of the number and relative position of the holes (25′) of different dimension in each one of said regions (considering the sequence of holes (25, 25′) from the left to the right).

In a first case (drawing on the left-side), the holes (25) that present a smaller characteristic dimension are provided in a second and fourth positions, whereas in a second case (drawing on the right-side) the holes (26) are provided in a first, third and fifth position. As in the previous case, also in this case the supports (2) of single portions can be used for different types of beverages.

Moreover, according to another preferred embodiment, at least some of said holes (25) are adapted so as to engage with corresponding engaging elements, in particular with traction pins (not represented) provided in the actuation device (5), so as to provide a more efficient transfer of the traction force to said support (2) of single portions. Considering the width of the support (2) of single portions, this solutions advantageously increases the efficiency and reliability of transfer of movement to the support (2) of single portions, so that it is preferred when there are provided at least two holes (25) for engagement and the remanding for representation of information in the form of a binary code.

FIG. 6 represents a first embodiment of a machine (10) for preparing beverages and adapted for using a supply cartridge (1) of the type of the present invention. In particular, the machine (10) presents a collection disposition (3) configured in a form that substantially corresponds to the form of the base zone of said types of supply cartridges (1, 1′), in particular to the respective width (W) and depth (D). In this case, said collection disposition (3) is configured with the form of a substantially parallelepiped box.

According to a preferred embodiment, a first type of supply cartridge (1) can be completely collected inside of said collection disposition (3) and temporarily closed in the front and top faces thereof. In particular, said collection disposition (3) presents front (32) and top parts (33) adapted so that can be fixated in removable manner or so that can be rotated around an axis, thereby facilitating the placement of at least one type of cartridge, preferentially of at least two types of supply cartridge (1, 1′).

As one can also observe, said supply cartridge (1) further presents an information device (6), provided for example in the form of a RFID or similar, and disposed in the front face thereof so that said information device (6) can be read by a device adapted correspondingly and disposed in said front part.

Moreover, according to another inventive aspect, said collection disposition (3) presents fixation means (31) disposed inside and adapted so that exert an elastic pressure upon at least part of the side faces of said supply cartridges (1, 1′). In the case of the represented embodiment, said fixation means (31) are provided in a U-like form, with the opening oriented towards the front zone and adapted so that exert an elastic pressure upon the side faces of the supply cartridge (1). This type of fixation advantageously provides a rapid placement of the supply cartridge (1) in position, without requiring a particular intervention by a user. Moreover, this type of solution provides a sufficient fixation of the supply cartridge (1) relative to the traction force exerted in the front zone of the supply cartridge (1) upon a support (2) of single portions, so that the movement of the latter results more efficient and reliable.

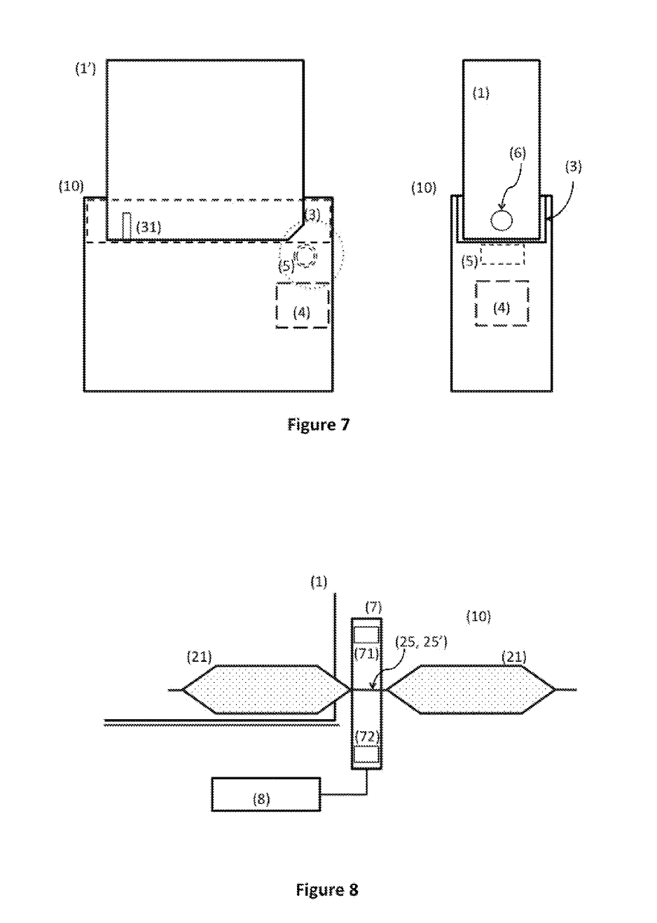

FIG. 7 represents a second embodiment of the collection disposition (3).

According to this preferred embodiment, said fixation means (31) are provided as at least one pair of fixation means (31) disposed in opposition, at least at a distal region of said collection disposition (3) relative to the front part of the machine (10). Said fixation means (31) are provided as elastic elements adapted so that they are elastically deformed at the time of placing of a supply cartridge (1), thereby exerting an elastic pressure force upon the side faces of said supply cartridge (1). According to a preferred embodiment, said fixation means (31) present an extension of at least 1 cm, preferentially at least 2 cm, along the direction of depth (D) of said machine (10) for preparing beverages.

FIG. 8 shows a simplified detail view of the machine (10) according to the present invention, between the exit of the supply cartridge (1) and the actuation device (5).

In particular, the machine (10) presents information apprehension means (7) adapted so that they can recognize the number and/or dimension and/or form of the holes (25, 25′) provided in said support (2) of single portions, preferentially disposed in the region between at least part of successive single dose portions (21), whereby said information apprehension means (7) are provided in functional connection with a control device (8) of said machine (10).

According to a preferred embodiment, said information apprehension means (7) are disposed in a region downstream of the exit of said supply cartridge (1), preferentially between said collection disposition (3) and an actuation device (5) and comprise lighting means (71) adapted so as to light up said support (2) of single portions and image collection means (72) adapted so as to recognize at least the number of holes (25), preferentially also the form and/or dimension of the holes (25) in each respective position.

According to another preferred embodiment, said lighting means (71) are provided underneath or above of the passage region of said support (2) of single portions and said image collection means (72) are provided in direct opposition to said lighting means (71), on the other side of said passage region.

A process of preparation of beverages based upon said machine (10) thus includes the steps of actuating said information apprehension means (7), provided downstream of the exit of said supply cartridge (1), so as to collect information provided in the form of a binary code, preferentially in the dividing region between successive single dose portions (21), and communicating at least one respective information parameter to a control device (8) of said machine (10).

According to a preferred embodiment, said step of actuation of the information apprehension means (7) is initialized after each actuation of said actuation device (5), so as to apprehend the information that is coded in the holes (25, 26) provided between successive single dose portions (21).

1. A supply cartridge (1) comprising:
a package adapted for housing a support (2) of single portions,
whereby said support (2) of single portions is provided in a strip-like form, or similar, with a support extension (E) and comprising a plurality of single dose portions (21) containing at least one edible substance, whereby said support (2) of single portions is provided with a first downstream edge (22) in the proximity of a package corner (12) where there is provided an exit opening, and presenting a plurality of holes (25, 25′, 26) adapted so as to provide regions of different light transmission relative to the remanding support (2),
characterized in that said support (2) of single portions presents a plurality of holes (25, 25′, 26) disposed along a single cross alignment at least in a first and second dividing region between successive single dose portions (21), and
in that at least one of said holes (25, 25′, 26) presents at least one of different number, form and dimension in at least part of said dividing regions between successive single dose portions (21), so that said holes (25, 25′, 26) provide a machine readable code support adapted to the type of edible substance and to the relative position of at least some of said successive single dose portions (21) along said support extension (E).

2. The supply cartridge (1) according to claim 1, characterized in that said support (2) of single portions presents at least two holes (25, 26) of different forms, including of circular type and of polygonal type, at least in a first and in a second dividing region between successive single dose portions (21).

3. The supply cartridge (1) according to claim 1, characterized in that said support (2) of single portions presents at least two holes (25, 25′) of similar form and decreasing dimension, at least in a first and in a second dividing region between successive single dose portions (21).

4. The supply cartridge (1) according to claim 1, characterized in that said support (2) of single portions presents said holes (25, 25′, 26) in reference positions at previously defined equidistant distances between each other, and in that at least one of said positions does not present hole (25, 25′, 26) in at least one of said reference positions, so that each sequence of holes in respective positions corresponds to a position of a code of binary form.

5. The supply cartridge (1) according to claim 1, characterized in that said support (2) of single portions does not present holes (25, 25′, 26) in dividing regions between successive single dose portions (21).

6. The supply cartridge (1) according to claim 1, characterized in that said support (2) of single portions presents holes (25, 25′, 26) in dividing regions intercalated between a plurality of successive single dose portions (21).

7. The supply cartridge (1) according to claim 1, characterized in that said holes (25, 25′, 26) present a characteristic dimension, including diameter or cross dimension, of at least 0.5 mm, preferentially at least 1 mm.

8. The supply cartridge (1) according to claim 1, characterized in that said support (2) of single portions presents a width (L) comprised between 40 and 60 mm, preferentially between 45 and 55 mm and in that said support (2) of single portions presents a plurality of single dose portions (21) with a length (C) between 40 and 70 mm, preferentially between 50 and 60 mm.

9. The supply cartridge (1) according to claim 1, characterized in that said support (2) of single portions presents between 10 and 120 single dose portions (21), preferentially between 20 and 80 single dose portions along a respective extension (E).

10. A machine (10) for preparing beverages, presenting:
a collection disposition (3) adapted for collecting at least one type, preferentially at least two types of supply cartridge (1, 1′) of different dimensions, in particular supply cartridges (1, 1′) according to claim 1, and
an actuation device (5) adapted to pull said support (2) of single portions
further including an information reader (7), which is adapted to recognize at least one of number, dimension and form of holes (25, 25′, 26) provided in dividing regions between successive single dose portions (21) along said support (2) of single portions,
whereby said information reader (7) is provided in functional connection with a control device (8) of said machine (10).

11. The machine (10) according to claim 10, characterized in that said information reader (7) is provided in a downstream region at the exit of the cartridge (1), preferentially between said collection disposition (3) and actuation device (5) and comprise lighting means (71) adapted so as to light up said support (2) of single portions, and image collection means (72) adapted to recognize at least one of number of holes (25), preferentially also form and/or dimension of holes (25) in each respective position.

12. The machine (10) according to claim 10, characterized in that said lighting means (71) are provided underneath or above of the passage region of said support (2) of single portions and said image collection means (72) are provided in direct opposition to said lighting means (71), on the other side of said passage region.

13. A process of preparation of a beverage, comprising the steps:
providing a machine (10) for preparing beverages, in particular a machine (10) for preparing beverages that presents an actuation device (5) provided so that can rotate around a horizontal axis and disposed upstream of an extraction device (4);
providing a supply cartridge (1) comprising a support (2) of single portions in strip-like form or similar, and presenting a plurality of single dose portions (21), in particular a supply cartridge according to claim 1;
placing said supply cartridge (1) in a collection disposition (3) of said machine (10), preferentially by means of at least one elastic retention inside of said collection disposition (3);
placing a single dose portion (21) that is furthest downstream in said support (2) of single portions in interaction with an exterior surface of said actuation device (5),
actuating said actuation device (5) in a rotation movement so that displaces said support (2) of single portions by means of traction,
actuating information apprehension means (7) provided downstream of the exit of said supply cartridge (1) and upstream of said extraction device (4), so as to collect at least one information parameter in the form of binary code as a function of a least one of number, sequence, dimension and form of holes (25, 25′, 26) provided in dividing regions between successive single dose portions (21), and
communicating at least one information parameter to a control device (8) of said machine (10).

14. The process according to claim 13, characterized in that said step of actuating information apprehending means (7) is initialized after each actuation of said actuation device (5).

15. Process according to claim 13, characterized in that the steps are repeated for each beverage preparation cycle, by means of rotating said actuation device so as to correspond to the advancement by one position in each operation cycle.
